(19) United States
(12) Patent Application Publication
(10) Pub. No.: US 2013/0326930 A1
(43) Pub. Date: Dec. 12, 2013

(54) REMOVABLE BAIT COOLER

(71) Applicant: Ernie Austin Reyes, Cutler Bay, FL (US)

(72) Inventor: Ernie Austin Reyes, Cutler Bay, FL (US)

(21) Appl. No.: 13/490,922

(22) Filed: Jun. 7, 2012

(51) Int. Cl. A01K 97/04; A01K 99/00

(52) U.S. Cl. 43/54.1; 43/4

(57) ABSTRACT

A removable bait cooling having an outer container defining an first upper opening and an inner cooler zone and a plurality elongated of inner cooler members, each of the elongated inner cooler members with a first end, a second end opposite to the first end, and a substantially watertight sidewall separating the first and second ends with the sidewall at least partially defining a bait placement zone. The elongated inner cooler members also having a substantially watertight bottom surface at least partially defining the bait placement zone and a second upper opening defined by the second end of the inner cooler member, being coupled to at least one other inner cooler member, and being removable from, and insertable within, the first upper opening as a unit.

### FIELD OF THE INVENTION

The present invention relates generally to a structure to store and hold fishing bait and, more particularly, relates to a structure having a plurality of removable compartments to hold natural bait.

### BACKGROUND OF THE INVENTION

Fishing has, and is, an important piece in the fabric of most civilizations. Some people fish for recreation, some for sport, and some for commercial purposes. Regardless the purpose, there are many different methods utilized to catch fish. Some involve utilizing nets or traps, but most use angling, or employing the use of a hook. The hook is attached to fishing line, the length of which is controlled by the angler. Bait is then generally attached to the hook, which in turn lures a fish to bite, thereby causing the hook to pierce the mouthparts of the fish. Many hooks also utilize barbs to prevent the fish from become dislodged. The type of bait utilized becomes an important choice for anglers as certain fish are attracted to, or consume, only certain types of food.

The classes of bait available are generally either artificial or natural. Artificial bait is man-made to attract a certain species of fish. Artificial bait is problematic for many anglers because it lacks many qualities possessed by natural bait, such as the texture, odor, and color. This dissuades many species of fish from being lured by and biting on the hook. Moreover, artificial bait is also generally more expensive than natural bait, which becomes quite costly for anglers, as bait is often lost in the fishing process by broken fishing lines or mechanical failure of the artificial bait itself. As a result, most anglers resort to using natural bait, specifically utilizing the prey species of the fish they desire to be caught.

Natural bait is generally separated into either live or dead bait. Those known containers that hold/store live bait usually require more space and aeration for the bait to remain alive. This usually attributes to higher costs and more maintenance on the container. As the fish are alive and contained within the same space, they are also generally not able to be pre-hooked for casting out, as the lines will cross and tangle with one another. As such, an angler must take the time after losing the bait attached on a line and reattach a new one. This is especially problematic for sport fishermen, where time is of the essence.

There are many known containers utilized to hold/store/organize bait, whether it is natural or artificial. Some known containers have a large insulated outer container, e.g., a cooler, with one or more dividers within that define smaller compartments used to separate and organize the bait. Most of these dividers, however, are not removable, which makes cleaning and maintaining the smaller portions of the compartments (where the fish are held) difficult. This leads to accumulated debris that facilitates the development of unpleasant odors and bacteria. Moreover, as the dividers are not removable, transporting the fish to other containers is very difficult and time-intensive, thereby requiring the user to transport the entire larger container. Some known containers that have removable dividers also do not provide the ability to easily insert that divider into another cooler with a cooling medium, such as ice. Some compartments do not have a bottom surface that allows the cooling medium to infiltrate space where the bait is stored. Those known compartments that are somewhat waterproof generally are permanently affixed to the outer container and are not removable to be transported to another outer container. Furthermore, those known bait cooler do not permit a cooling medium, e.g., ice, from coming in contact with the outer surface of all of the compartments, which causes inefficient and not a very effective cooling process.

As mentioned, many known bait containers are specifically designed for live bait or artificial bait. Most of these containers have multiple apertures either on the bottom surface or sidewalls. These apertures then allow fluid, such as water, to exchange between an interior of the bait storing compartments and the inside of the larger container in which the bait storing compartment resides. For artificial bait, the exchange of fluid is done to prevent the accumulation of water within the compartments, which may cause rust or corrosion. For natural-live bait, the exchange of fluid between the bait containers allows one section of the bait container to aerate the others. For those anglers that utilize natural-dead bait when fishing, however, the exchange of fluid can be detrimental and extremely problematic to the structural integrity of the bait. The integrity of dead bait is generally a function of temperature and exposure to fluid and rubbing contact with ice. Higher temperatures, prolonged exposure to water, and rubbing against ice degrades the bait, thereby making it difficult to handle or keep attached to the line. As the bait degrades, this also leads to the formation of bacteria and organisms that may be unsafe for the angler and the ecosystems where the fish are located. The apertures on the bait compartments are also problematic as they may prevent the bait from being pre-hooked for casting out, as the hooks may catch on the apertures.

It should also be noted that most, if not all, bait containers do not have the ability to lift the bait contained within the compartments without completely removing the containers. As such, most containers require the anglers to stick their hands in the container. This increases the chances of an angler injuring him or herself by the hook or by the fish themselves, i.e., the scales or teeth. Lastly, many known bait holders do not specifically provide the user with the ability to adjust the bait holder to effectively displace ice, when used as cooling medium, and then subsequently allowing that same bait holder to be effectively removed from a cooler and placed on the surface of boat without the holder sliding. As such, those known bait containers do not provide the ability to maintain and transport natural-dead bait safely and effectively.

Therefore, a need exists to overcome the problems with the prior art as discussed above.

### SUMMARY OF THE INVENTION

The invention provides a removable bait cooler assembly that overcomes the hereinafore-mentioned disadvantages of the heretofore-known devices and methods of this general type and that provides a plurality of containers that hold and support natural-dead bait hooked on a fishing line.

The present invention further provides a bait cooler that has a plurality of bait holders that are removable from a cooler and easily transportable from one location to another.

With the foregoing and other objects in view, there is provided, in accordance with the invention, a bait cooler assembly that has an outer container defining an first upper opening and an inner cooler zone and a plurality of elongated inner cooler members. Each of the plurality of inner cooler members have a first end, a second end opposite to the first end, and a substantially watertight sidewall separating the first and second ends, with the sidewall at least partially defining a bait placement zone. Each of the plurality of inner cooler members also have a substantially watertight bottom surface at least partially defining the bait placement zone, a second upper opening defined by the second end of the inner cooler member, are coupled to at least one other inner cooler member, and are removable from, and insertable within, the first upper opening of the outer container as a unit.

In accordance with another feature, an embodiment of the present invention includes at least two members of the plurality of elongated inner cooler members, when placed within the outer container, to extend substantially from a bottom surface of the outer container substantially to the first upper opening.

In accordance with an additional feature, another embodiment of the present invention includes at least two members of the plurality of elongated inner cooler members at least partially defining at least one slot.

In accordance with yet another feature, an embodiment of the present invention includes the at least one slot extending upwardly from the first end towards the second end of at least one member of the plurality of elongated inner cooler members.

In accordance with an additional feature, another embodiment of the present invention includes the at least one slot having at least one portion with a slot area of approximately 1 inch squared separating at least two members of the plurality of elongated inner cooler members.

In accordance with a further feature of the present invention, the plurality of elongated inner cooler members have a handle coupled thereto.

In accordance with an additional feature, another embodiment of the present invention includes the substantially watertight sidewall downwardly tapering to the first end of at least two members of the plurality of elongated inner cooler members.

In accordance with yet another feature, an additional embodiment of the present invention includes at least two first ends of the plurality of the elongated inner cooler members each defining a first translation path that includes a first position defining a first lower contact surface area and a second position defining a second lower contact surface area, the first lower contact surface area being greater than the second lower contact surface area.

In accordance with another feature, another exemplary embodiment of the present invention includes the watertight bottom surface of at least one member of the plurality of the elongated inner cooler members defining a second translation path that includes a first position with a first length separating the bottom surface and the second upper opening and a second position with a second length separating the bottom surface and the second upper opening, the second length being less than the first length.

In accordance with the present invention, and in combination with a cooler that defines a first upper opening and an inner cavity sufficient to store and retain a cooling medium, the present invention includes having a plurality of elongated inner cooler members, each having a first end, a second end opposite to the first end, and a substantially watertight sidewall separating the first and second ends, with the sidewall at least partially defining a bait placement zone. The elongated inner cooler members also each having a substantially watertight bottom surface at least partially defining the bait placement zone, having a second upper opening defined by the second end of the inner cooler member, are coupled to at least one other inner cooler member, at least partially define at least one slot extending upwardly from the first end towards the second end of at least one member of the plurality of inner cooler members, and having a height sized to fit substantially within the inner cavity of the cooler.

In accordance with another feature, an embodiment of the present invention includes the plurality of inner cooler members defining a plurality of slots extending upwardly from the first ends toward the second ends of at least two members of the plurality of inner cooler members.

In accordance with the present invention, a method for storing natural-dead bait also includes the steps of providing an outer container that defines a first upper opening and an inner cooler zone, providing a plurality of elongated inner cooler members. Each of the plurality of elongated inner cooler members having a first end, a second end opposite to the first end, and a substantially watertight sidewall separating the first and second ends, the sidewall at least partially defining a bait placement zone. The plurality of elongated inner cooler members also have a substantially watertight bottom surface located at the first end and at least partially defining the bait placement zone, a second upper opening defined by the second end of the inner cooler member, and are coupled to at least one other inner cooler member. The method further includes the steps of placing natural-dead bait within at least one second upper opening of the plurality of inner cooler members and removably-inserting the plurality of inner cooler members substantially within the inner cooler zone of the outer container as a unit.

Although the invention is illustrated and described herein as embodied in a removable bait cooler, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction from the bottom surface to the top edge of the compartments.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective, downward-looking, view of a bait cooler assembly with an outer cooler container and a plurality of inner cooler members inserted within the outer cooler container in accordance with the present invention;

FIG. 2 is a elevational side view of the bait cooler assembly of FIG. 1 with the inner cooler members inserted within a container filled with ice, in accordance with an embodiment of the present invention;

FIG. 3 is a perspective, partially cross-sectional, view of an inner cooler member with a downwardly tapered sidewall, in accordance with an embodiment of the present invention;

FIG. 4 is a perspective view of an inner cooler member with a first end that is translatable upwardly and downwardly to expose a tapered sidewall, in accordance with an exemplary embodiment of the present invention;

FIG. 5 is a perspective, partially cross-sectional, view of the inner cooler member of FIG. 4 in a first position along a first translation path, in accordance with an embodiment of the present invention;

FIG. 6 is a perspective, partially cross-sectional, view of the inner cooler member of FIG. 4 in a second position along the first translation path, in accordance with an embodiment of the present invention;

FIG. 7 is a perspective, partially cross-sectional, view of an inner cooler member with a bottom surface in a first position along a second translation path in accordance with another exemplary embodiment of the present invention; and

FIG. 8 is a perspective, partially cross-sectional, view of the inner cooler member of FIG. 7, with the bottom surface in a second position along the second translation path, in accordance with an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient bait cooler assembly that effectively stores and organizes natural-dead bait in a cool environment without exposing the bait to fluid and ice that may cause degradation of the bait. In addition to the above, the present invention provides an angler with the ability to access and remove pre-hooked bait quickly and safely. Embodiments of the invention also permit a plurality of compartments that hold the bait to be removed from one cooler and placed within another cooler easier and more effectively than those prior-art bait holders.

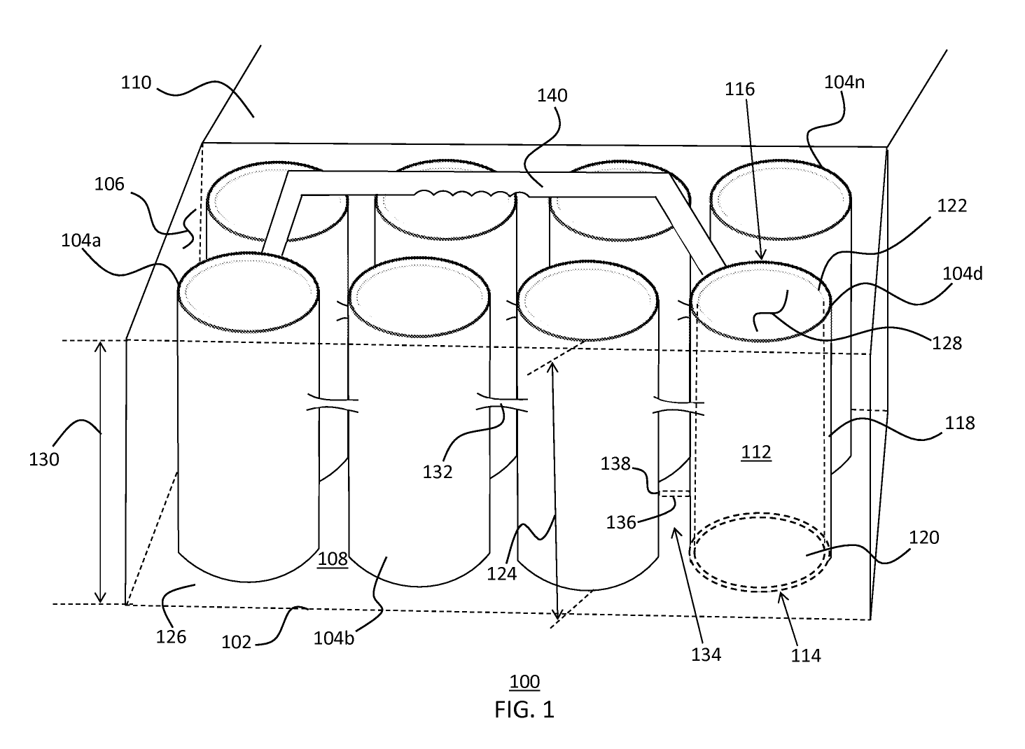

Referring now to FIG. 1, one embodiment of the present invention is shown in a perspective downward-looking view. FIG. 1 shows several advantageous features of the present invention, but, as will be described below, the invention can be provided in several shapes, sizes, combinations of features and components, and varying numbers and functions of the components. The first example of a bait cooler 100, as shown in FIG. 1, includes an outer container 102 with a plurality of inner cooler members 104a-n. As used herein, the nomenclature “a-n” is intended to represent a numerical range starting from any number “a” and spanning to any number “n” that is greater than the number “a.”

The outer container 102 defines a first upper opening 106 and an inner cooler zone 108. In one embodiment, the outer container 102 is a standard-sized cooler that has an inner cooler zone 108 holding approximately 20-30 quarts of liquid and is enclosed to prevent any liquid from escaping. In other embodiments, the outer container 102 has a capacity greater or less than 20-30 quarts, may not be insulated, or may have one or apertures to drain any liquid contained therein. As appreciated by those skilled in the art, the present invention may be utilized with various-sized outer containers 102 having an upper opening 106 and the ability to store a cooling medium such as ice or cold water. Furthermore, the construction of outer container 102 may be made from materials such as polymers, composites, or various metals.

In one embodiment, the plurality of cooler members 104a-n may be sized to be placed within various-sized outer containers 102. The inner cooler members 104a-n may be sized according to, and sold with, a specific container 102, as exemplified in FIG. 1, and made from a light-weight yet strong plastic that makes transportation undemanding for the user. In other embodiments, the outer container 102 has a cover 110 that, when closed, prevents debris or liquid from entering the bait placement zone 112 of the cooler members 104a-n. The cover 110 may then fasten to one or more portions of the outer container 102. In other embodiments, one or more inner cooler members 104a-n may also have a cover (now shown) that shields the bait from liquid while in the bait placement zone 112. Each cover may also have one or more apertures that allow a fishing line, which is attached to the hooked bait, to extend outside of the outer container 102. This allows a user to grab and attach the line to a fishing pole easier and more effectively than those known prior-art bait containers. As the construction of the assembly 100 may be made in a singular piece of material, it also facilities easier and quicker cleaning/maintenance than was previously accomplished by the prior-art bait coolers, which generally utilize multiple components.

When in operation, the user fills the inner cooler zone 108 with ice, or other cooling medium, that is at a temperature lower than the ambient air temperature. The inner cooler members 104a-n are then placed within the inner cooler zone 108, which forcefully displace the ice away. The inner cooler members 104a-n each have a first end 114 and a second end 116, with the second end 116 being opposite to the first end 114. With reference to inner cooler member 104d, which is partially cross-sectioned, a sidewall 118 can be seen separating the first and second ends 114, 116. The sidewall 118 is also shown at least partially defining the bait placement zone 112. The bait placement zone 112 is also at least partially defined by the bottom surface 120 of the inner cooler members 104a-n. In other embodiments, the bait placement zone 112 may also be partially defined by an upper edge/lip 122 of the inner coolers 104a-n or other attachments or components of the inner cooler members 104a-n. In accordance with the present invention, both the bottom surface 120 and sidewall 118 are substantially watertight. The term “substantially watertight” is defined as an object or surface that resists or inhibits, although not necessarily completely, the free exchange of liquid, e.g. water.

Opposed to artificial or natural-live bait, exposure to a substantial amount of moisture or rubbing contact with ice causes the natural-dead bait to be degraded and soft, making it difficult, if not impossible, to effectively attach a hook to the bait. As such, the bait placement zone 112 is relatively free from moisture/liquid produced by the cooling medium. In addition to the relatively moisture-free environment, the plurality of inner cooler members 104a-b subject the bait to a lower temperature than the ambient air temperature (when placed in the cooling medium). As such, the easily transportable bait cooler 100 enables any bait to remain in suitable condition to properly hook and lure a target fish longer than those known prior-art bait containers.

In one embodiment, the plurality of inner cooler members 104a-n are elongated and cylindrically shaped. They have an exemplary length 124 of approximately 0.5-2 feet, depending on the type of outer container 102 or bait that may be utilized. Said another way, should the cooler members 104a-n be sold in combination with an outer container 102, then at least two of the plurality of inner cooler members 104a-n extend substantially from a bottom surface 126 of the outer container 102 substantially to the first upper opening 106. The at least two inner cooler members, such as 104a and 104d, would provide support to the remaining members 104a-n when placed within the container 102 and prevent any liquid from entering the bait placement zone 112. In other embodiments, the plurality of inner cooler members 104a-n may vary, or be adjustable, in a length 124. Specifically, in one case, the cooler members 104a-n are less than the height 130 of the outer container 102 such that a user would only place the members 104a-n into an outer container 102 (filled with a cooling medium such as ice) until the upper edge/lip portion 122 of the members 104a-n are generally planar, or horizontally aligned, with the top surface of the cooler 102 to allow the cover 110 to close. In other cases, the inner cooler members 104a-n each vary in length 124, but the upper edge/lip portions 122 of each of the members 104a-n should be generally planar, or horizontally aligned, with one another. This would allow a user to know how far to place the cooler members 104a-n within the cooler 102 to prevent liquid from entering the bait placement zone 112.

In yet further embodiments, the inner cooler members 104a-n may take the form of various shapes, other than a cylindrical shape. For example, the inner cooler members 104a-n may be triangular, quadrilateral, or any elongated shape that defines a relatively moisture free bait placement zone 112. In one embodiment, the inner cooler members 104a-n may be made from a plastic, such as polyvinyl chloride, that is water resistant, yet durable to withstand being forcefully placed into the outer container 102 while filled ice, for example. In other embodiments, the inner cooler members 104a-n may be made from composites, metals, other polymers, a material that is covered with a water resistant coating, a combination of the above materials, and other water resistant materials with sufficient yield strength to displace a cooling medium such as ice. The configuration and shape of the inner cooler members 104a-n may also vary depending on the bait and the container 102 where the inner cooler members 104a-n are going to be inserted.

In order to receive and organize the bait, each plurality of inner cooler members 104a-b has a second upper opening 128. In one embodiment, the second upper opening 128 has a diameter of approximately 3 inches. In other embodiments, the diameter or length across the second upper opening 128 and the width of the bait placement zone 112 may be more or less than 3 inches, but should be sufficient enough to hold the bait, at least in a vertical direction, and not too large where it interferes with the outer container 102, e.g., a cooler, or other inner cooler members 104a-n.

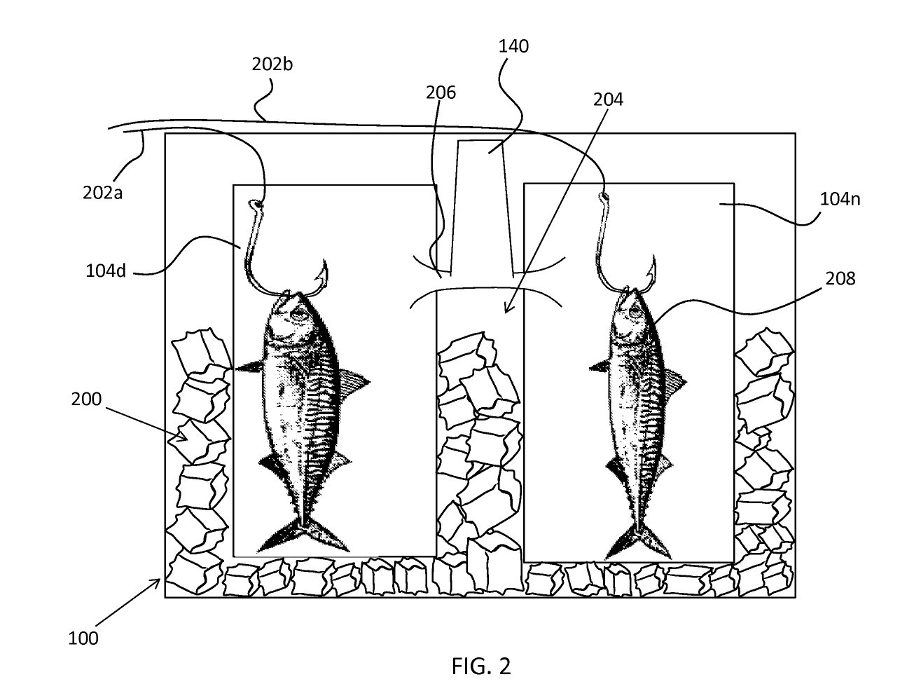

With reference now to both FIGS. 1 and 2, each of the inner cooler members 104a-n can be seen coupled to at least one of the other inner cooler members 104a-n. In one embodiment, the plurality of inner cooler members 104a-n are coupled to one another in such a fashion such that they are removable from, and insertable within, the first upper opening 106 as a unit. This advantageously allows a user to remove the inner cooler members 104a-n in a singular motion, without the need to remove individual cooler members. It also prevents the one or more inner cooler members 104a-n from tipping over when being removed, thereby protecting the bait from potential water exposure that may, over time, degrade the bait's structural integrity. In other embodiments, the plurality of inner cooler members 104a-n may have attachment buckets or a container that is/are removably couplable thereto, but may not be removed with members 104a-n as a unit. The coupling of the cooler members 104a-n as a unit also facilitates them penetrating the ice and distributing that ice evenly through the outside of each of the members 104a-n.

The configuration of inner cooler members 104a-n is shown with multiple rows, such that the members 104a-b are coupled with two other members 104a-n. As the inner cooler members 104a-n may be placed in various configurations, the coupling contact points may also vary. For example, the first coupling contact 132 horizontally couples at least two adjacent inner cooler members 104a-n together. Another coupling contact 206 includes vertically coupling at least two members 104a-n together. The coupling contacts 132, 206 provide structural stability to the inner cooler members 104a-n in order to effectively allow them forcibly and effectively displace the cooling medium without mechanical failure, as shown in FIG. 2. The contacts 132, 206 also permit the plurality of inner cooler members 104a-n to be removed and transported as a singular unit. In one embodiment, the members 104a-n are coupled together during the manufacturing process, e.g., a mold. In other embodiments, the members 104a-n are coupled to together with adhesives, wire ties, or other similar attaching methods. In further embodiments, two or more inner cooler members 104a-n may be coupled together with a male-female connection, such that one or more of the members 104a-n may be removable to create various configurations.

FIG. 2 illustrates two of the plurality of inner cooler members 104a-n partially submerged into the cooling medium, i.e. ice 200, as previously discussed. The assembly 100 is also beneficial for many anglers who pre-hook their bait on the fishing line 202a-b, as shown, because it does not allow the hooked bait to become tangled with other bait while being stored. Rather, the fishing line 202a-b is pulled outside of the outer container 102 and ready to be spliced or coupled to a fishing line that is attached to a reel of a fishing pole. The bait cooler assembly 100 is specifically advantageous for those anglers who fish for sport, where time is of the essence, because the pre-hooked bait 208 is readily available. The bait cooler 100 also allows the bait to be utilized quickly without any deterioration that is generally associated with storing natural-dead bait in a container/cooler with ice.

With reference still to FIGS. 1 and 2, each of the plurality of inner cooler members 104a-n can be seen at least partially defining and being separated from another of the members 104a-n by a plurality of slots 134, 204. In other embodiments, some inner cooler member 104a-n may have slots 134, 204 and others may not. Should there only be two inner cooler members 104a-n, then at least two of the plurality of elongated inner cooler members at least partially define a slot 134. The slots 134, 204 can be seen separating each of the inner cooler members 104a-b in order to allow the cooling medium 200, i.e. ice, to fill the width 136 of the slot 134. The configuration and dimensions of the slots 134, 204 may vary, but, in one embodiment, one or more slots 134, 204 have a portion that has a slot area of approximately 1 inch squared separating any two inner cooler members 104a-n. The slot area will include the width 136 and a length 138 of the slot 134.

One or more slots 134, 204 may also extend upwardly from the first end 114 of at least one of the inner cooler members 104a-n towards the second end 116. The slot area and height of the slots 134, 204 create a space and outer surface of the members 104a-n that is in more contact with the ice. This provides a lower temperature in the bait placement zone 112 than is typically available in those known prior-art coolers. The slots 134, 204 shown in FIGS. 1 and 2 are only exemplary, and the one or more slots 134, 204 may have various configurations, shapes, and dimensions.

As previously discussed, the plurality of inner cooler members 104a-n are removed and inserted with the outer container 102 as a unit. This may be accomplished by grabbing onto one or more members themselves. In other embodiments, the inner cooler members 104a-n have a handle 140 coupled thereto. The handle 140 facilitates the removal and placement of the inner cooler members 104a-n with the outer container 102. The handle 140 also facilitates the transportation of the members 104a-n from one cooler to another more effectively than prior-art bait coolers. In one embodiment, the handle 140 may couple to the coupling contacts 132, 206. In other embodiments, the handle 140 may be coupled to another portion of the members 104a-n. The handle 140 may also be a substantially rigid material in order to resist the forces created when placing (and removing) the members 104a-n in a container 102 filled with ice. Now, advantageously, the inner cooler members 104a-n provide a user with the ability to transport, or caddy, around natural-dead bait without worrying about the bait being degraded or compromised by the cooling medium 200.

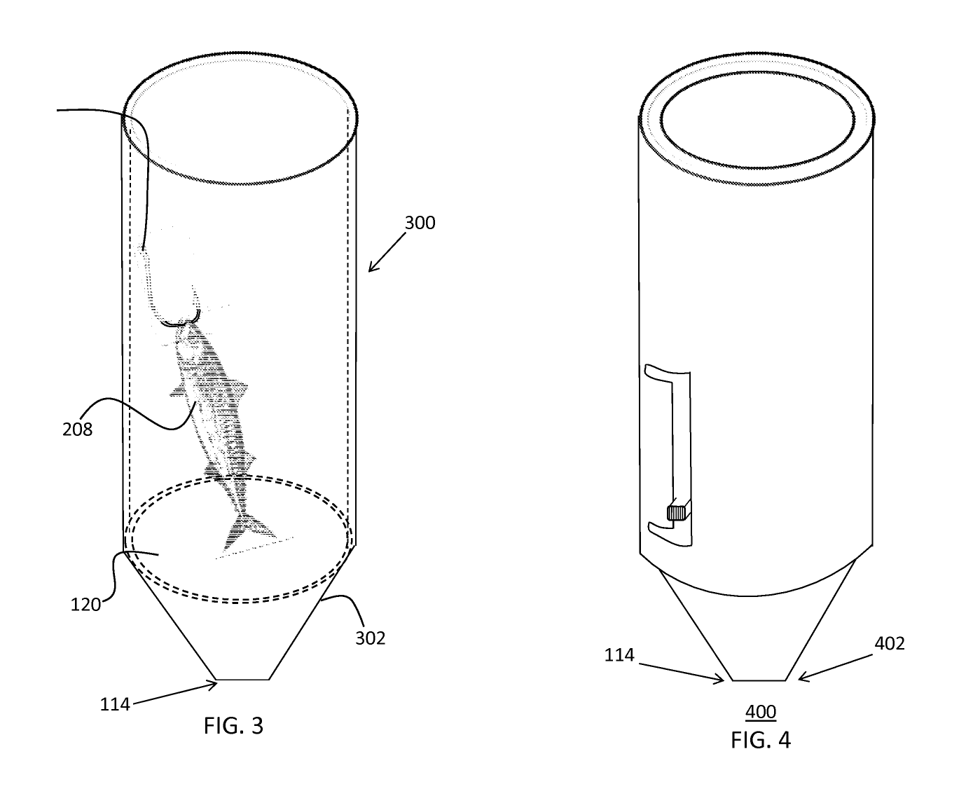

With reference now to FIG. 3, an inner cooler member 300 is illustrated as having a sidewall 302 that downwardly tapers to the first end 114. As one goal of the present invention is for a bait cooler to effectively store bait within a cooler having ice, the tapered sidewall 302 assists the members 104a-n in effectively displacing the ice. In one embodiment, two of the plurality of inner cooler members 104a-n have a downwardly-tapered sidewall 302. In other embodiments, more than two inner cooler members 104a-n have tapered side walls. Further, in some embodiments the entire outer surface of the sidewall 302 is tapered, and in other embodiments, it may not be. The tapered sidewall 302 further helps facilitate one or more of the plurality of inner cooler members in reaching the bottom surface 126 (shown in FIG. 1) of the outer container 102 and to be exposed to more ice. The bottom surface 120 of the inner cooler member 300 may be generally planar. In other embodiments, bottom surface 120 may also be tapered in combination with the sidewall 302 or may be in another shape or dimension that supports the bait 208.

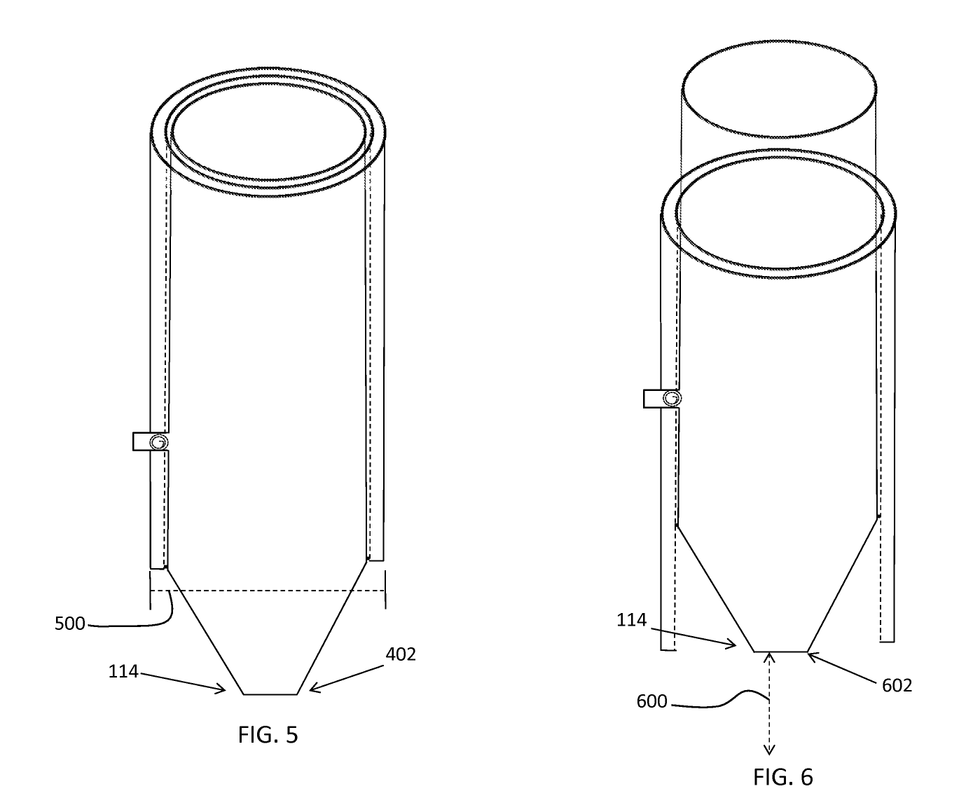

With reference to FIGS. 4 through 6, another embodiment of the inner cooler member 400 is illustrated in accordance with another feature of the present invention. In one embodiment, at least two first ends 114 of the plurality of the elongated inner cooler members 400 each define a first translation path 600 that includes a first position 402 defining a first lower contact surface area and a second position 602 defining a second lower contact surface area, the first lower contact surface area being greater than the second lower contact surface area. The above referenced surface area referred to is the total width 500 and not the actual surface area in contact with a floor surface. This advantageously allows the user to place the first end 114 of the inner cooler member 400 in a tapered configuration, capable of effectively penetrating the ice or other cooling medium. In the second position 602, it further allows the user to place the first end 114 of the inner cooler member 400 in a configuration that provides a wider base that prevents the inner cooler member 400 from sliding or tipping over should they be placed on a floor surface. This can be significantly important for those anglers who may remove the inner cooler members 104a-n from the cooler 102 and place it on the deck of a boat that may be slippery. The wider first end 114 of the inner cooler members 104a-n provides more stability for the members 104a-n, should they be removed from the container 102. In other embodiments, the first end 114 may have rubber or other materials attached thereto that resist lateral movement. This allows the plurality of inner coolers 400a-n to be removed from (and inserted within) multiple coolers and placed on the deck of a boat with the inner coolers 104a-n resisting lateral movement associated with the movement of the boat.

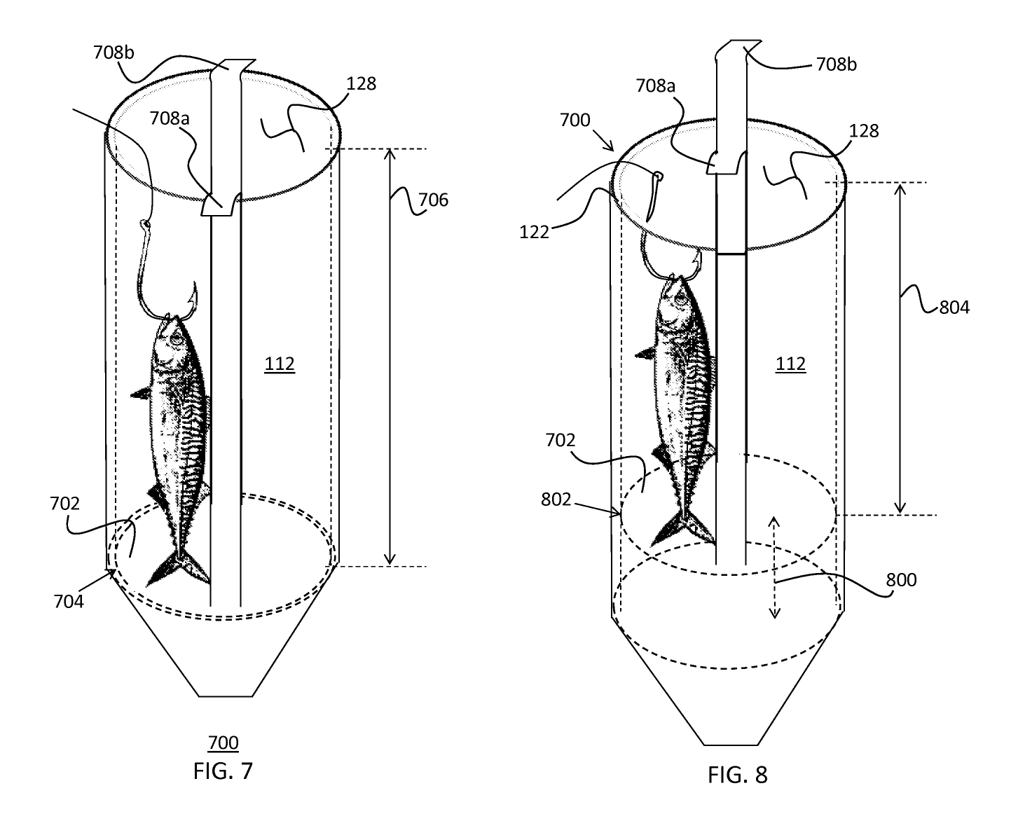

With reference to both FIGS. 7 and 8, FIGS. 7 and 8 illustrate another embodiment of the inner cooler member 700 in accordance with another feature of the present invention. As shown, the bottom surface 702 of at least one of the plurality of the elongated inner cooler members 104a-n defines a second translation path 800 (shown in FIG. 8) that includes a first position 704 (shown in FIG. 7) with a first length 706 separating the bottom surface 702 and the second upper opening 128 and a second position 802 (shown in FIG. 8) with a second length 804 separating the bottom surface 702 and the second upper opening 128, the second length 804 being less than the first length 706. Many anglers, specifically those involved in competitive sport fishing, are concerned with placing the bait on the hook as fast as possible. As such, much of the bait is pre-hooked onto a line that is then coupled to the fishing line attached to the reel of a rod. When an angler desires to use the bait, they generally reach into the placement zone 112 without seeing where the bait or hook is. This causes many anglers to injure themselves on the barbed hook or, in some cases, the barbs, scales, or teeth of a fish. As described, should the bait not be pre-hooked, the bottom surface 702 is capable of being vertically translated along the second translation path 800 that permits the bait to be exposed for the angler to grab.

In one embodiment, one or more tabbed hooks 708a-b are attached to the bottom surface 702 and translate the bottom surface 702 upwardly. This allows any bait contained supported by the bottom surface 702 to be shown to the user so the user is not required to reach and see the bait, without standing over inner cooler member 700. The upper lip portion 122 of the inner cooler portion may also have one or more recessed portions that are shaped to receive the top portion of the hooks 708a-b, in order to facilitate a cover to be placed over the inner cooler member 700.

A bait cooler assembly and method for storing natural-dead bait has therefore been disclosed that provides a user with the ability to effectively store and maintain natural-dead bait in a condition acceptable for fishing. The bait cooler assembly and method further provide a user with the ability effectively and efficiently transport, and place, the bait in multiple locations without affecting the condition of the bait contained therein. Further embodiments of the invention provide a more effective means to store and maintain bait for the safety and convenience of the user.

What is claimed is:

1. A bait cooler assembly comprising:
an outer container defining an first upper opening and an inner cooler zone; and
a plurality of elongated inner cooler members, each:
having a first end, a second end opposite to the first end, and a substantially watertight sidewall separating the first and second ends, the sidewall at least partially defining a bait placement zone;
having a substantially watertight bottom surface at least partially defining the bait placement zone;
having a second upper opening defined by the second end of the inner cooler member;
coupled to at least one other inner cooler member; and
being removable from, and insertable within, the first upper opening as a unit.

2. The bait cooler assembly according to claim 1, wherein:
at least two members of the plurality of elongated inner cooler members, when placed within the outer container, extend substantially from a bottom surface of the outer container substantially to the first upper opening.

3. The bait cooler assembly according to claim 1, wherein:
at least two members of the plurality of elongated inner cooler members at least partially define at least one slot.

4. The bait cooler assembly according to claim 3, wherein:
the at least one slot extends upwardly from the first end towards the second end of at least one member of the plurality of elongated inner cooler members.

5. The bait cooler assembly according to claim 3, wherein
the at least one slot has at least one portion with a slot area of approximately 1 inch squared separating at least two members of the plurality of elongated inner cooler members.

6. The bait cooler assembly according to claim 1, wherein the plurality of elongated inner cooler members comprises:
a handle coupled thereto.

7. The bait cooler assembly according to claim 1, wherein:
the substantially watertight sidewall downwardly tapers to the first end of at least two members of the plurality of elongated inner cooler members.

8. The bait cooler assembly according to claim 1, wherein:
at least two first ends of the plurality of the elongated inner cooler members each define a first translation path that includes a first position defining a first lower contact surface area and a second position defining a second lower contact surface area, the first lower contact surface area being greater than the second lower contact surface area.

9. The bait cooler assembly according to claim 1, wherein:
the watertight bottom surface of at least one member of the plurality of the elongated inner cooler members defines a second translation path that includes a first position with a first length separating the bottom surface and the second upper opening and a second position with a second length separating the bottom surface and the second upper opening, the second length being less than the first length.

10. In combination with a cooler that defines a first upper opening and an inner cavity sufficient to store and retain a cooling medium, the improvement comprising:
a plurality of elongated inner cooler members, each:
having a first end, a second end opposite to the first end, and a substantially watertight sidewall separating the first and second ends, the sidewall at least partially defining a bait placement zone;
having a substantially watertight bottom surface at least partially defining the bait placement zone;
having a second upper opening defined by the second end of the inner cooler member;
coupled to at least one other inner cooler member;
at least partially defining at least one slot extending upwardly from the first end towards the second end of at least one member of the plurality of inner cooler members; and
having a height sized to fit substantially within the inner cavity of the cooler.

11. The combination of claim 10, wherein:
the plurality of elongated inner cooler members being removable from, and insertable within, the first upper opening as a unit.

12. The combination of claim 10, wherein
the at least one slot has at least one portion with a slot area of approximately 1 inch squared separating two members of the plurality of elongated inner cooler members.

13. The combination of claim 10, wherein the plurality of elongated inner cooler members comprises:
a handle coupled thereto.

14. The combination of claim 10, wherein:
the substantially watertight sidewall downwardly tapers to the first end of at least two members of the plurality of inner cooler members.

15. The combination of claim 10, wherein:
the plurality of inner cooler members define a plurality of slots extending upwardly from the first ends toward the second ends of at least two members of the plurality of inner cooler members.

16. The combination of claim 10, wherein:
at least two first ends of the plurality of the elongated inner cooler members each define a first translation path that includes a first position defining a first lower contact surface area and a second position defining a second lower contact surface area, the first lower contact surface area being greater than the second lower contact surface area.

17. The combination of claim 10, wherein:
the watertight bottom surface of at least one member of the plurality of the elongated inner cooler members defines a second translation path that includes a first position with a first length separating the bottom surface and the second upper opening and a second position with a second length separating the bottom surface and the second upper opening, the second length being less than the first length.

18. A method of storing natural-dead bait, comprising the steps of:
providing an outer container defining an first upper opening and an inner cooler zone;
providing a plurality of elongated inner cooler members, each:
having a first end, a second end opposite to the first end, and a substantially watertight sidewall separating the first and second ends, the sidewall at least partially defining a bait placement zone;
having a substantially watertight bottom surface located at the first end and at least partially defining the bait placement zone;
having a second upper opening defined by the second end of the inner cooler member; and
coupled to at least one other inner cooler member;
placing natural-dead bait within at least one second upper opening of the plurality of inner cooler members; and
removably-inserting the plurality of inner cooler members substantially within the inner cooler zone of the outer container as a unit.

19. The combination of claim 18, wherein:
The substantially watertight sidewall downwardly tapers to the first end of at least two members of the plurality of inner cooler members.

20. The combination of claim 18, wherein:
the plurality of inner cooler members define a plurality of slots extending upwardly from the first ends towards the second ends of at least two members of the plurality of inner cooler members.
